(19) United States
(12) Patent Application Publication
(10) Pub. No.: US 2012/0316909 A1
(43) Pub. Date: Dec. 13, 2012

(54) Maintaining Complex Equipment

(75) Inventors: James M. Haynes, III, San Francisco, CA (US); Anthony W. Ulwick, Mill Valley, CA (US)

(73) Assignee: Strategyn Equity Partners, LLC., San Francisco, CA (US)

(21) Appl. No.: 13/517,515

(22) Filed: Jun. 13, 2012

Related U.S. Application Data
(60) Provisional application No. 61/496,494, filed on Jun. 13, 2011.

(51) Int. Cl. G06Q 10/10

(52) U.S. Cl. 705/7.15

(57) ABSTRACT

A technique for automating complex equipment maintenance decisions is disclosed. It has been determined that a core job of maintaining complex equipment entails 14 different steps with 102 outcomes, or metrics, that job executors use to judge if they can effectively maintain complex equipment. The techniques described in this paper enable a system and method to satisfy the outcomes (customer needs) for the job of maintaining complex equipment.

### CROSS-REFERENCE TO RELATED APPLICATIONS

This application claims priority to U.S. provisional Ser. No. 61/496,494 filed Jun. 13, 2011, entitled “Maintaining Complex Equipment,” which is incorporated by reference.

### BACKGROUND

Maintaining complex equipment is functionally complex and entails a significant number of steps that must be accomplished by a job executor responsible for maintaining the equipment. Some examples of complex equipment are aircraft, wind turbines, and medical equipment.

Job executors sometimes use a process map to attempt to perform complex tasks. Some job executors in the past may or may not have attempted to use a process map for the purpose of maintaining complex equipment. However, a process map shows what a job executor is currently doing at any given point. Thus, the process map does not really help define what the customer hopes to accomplish when executing the job.

### SUMMARY

A technique for automating complex equipment maintenance decisions is disclosed. It has been determined that a core job of maintaining complex equipment entails 14 different steps with 102 outcomes, or metrics, that job executors (which are, in this paper, the persons executing the job of maintaining complex equipment) use to judge if they can effectively maintain complex equipment. The techniques described in this paper enable a system and method to satisfy the outcomes (customer needs) for the job of maintaining complex equipment.

### BRIEF DESCRIPTION OF THE DRAWINGS

FIG. 1 depicts a diagram of an example of a system for maintaining complex equipment.

FIG. 2 depicts a flowchart of an example of a job map for maintaining complex equipment.

FIG. 3 depicts a diagram of an example of a complex equipment maintenance platform.

FIG. 4 depicts a diagram of an example of a system for maintaining complex equipment.

FIG. 5 depicts a flowchart of an example of a method for maintaining complex equipment at a complex equipment maintenance platform.

### DETAILED DESCRIPTION

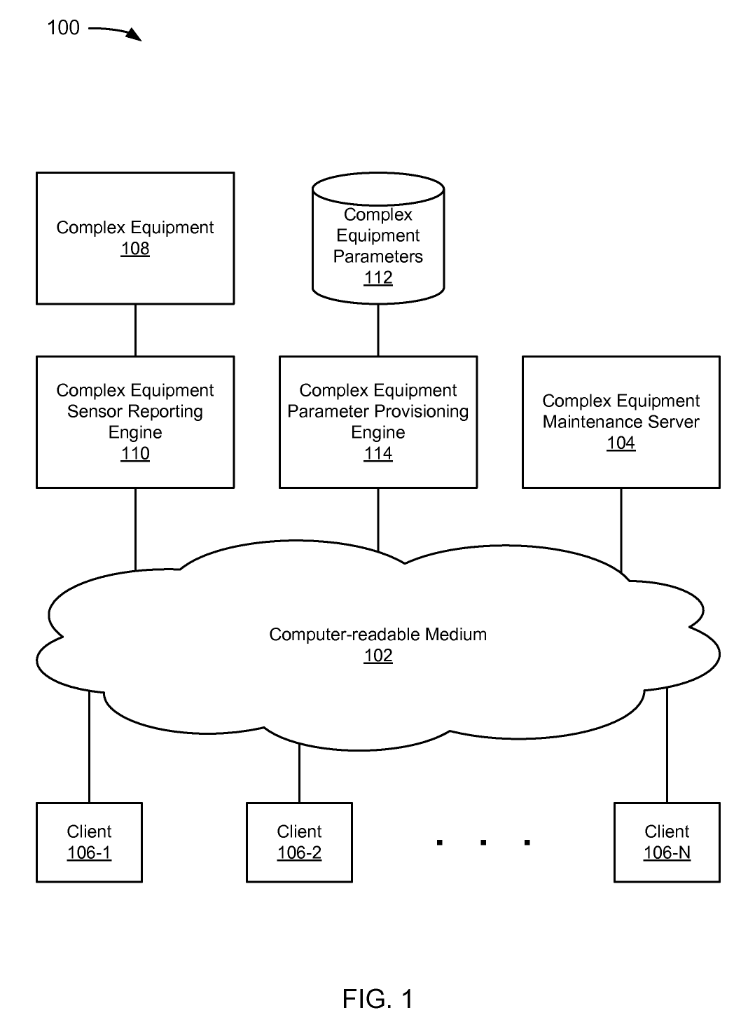

FIG. 1 depicts a diagram 100 of an example of a system for maintaining complex equipment. In the example of FIG. 1, the diagram 100 includes a computer-readable medium 102, a complex equipment maintenance server 104, clients 106-1 to 106-N (collectively, clients 106), complex equipment 108, a complex equipment sensor reporting engine 110, a complex equipment parameters datastore 112, and a complex equipment parameter provisioning engine 114.

In the example of FIG. 1, the computer-readable medium 102 can include communications hardware within a single computer, a device locally attached to a computer, or a networked system that includes several computer systems coupled together, such as a local area network (LAN), campus area network (CAN), municipal area network (MAN), or wide area network (WAN), but could include any applicable type of network, such as a personal area network (PAN).

A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor.

The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, the computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

Networks can include enterprise private networks and virtual private networks (collectively, private networks). As the name suggests, private networks are under the control of an entity rather than being open to the public. Where context dictates a single entity would control a network, it should be understood that reference to a network is a reference to the private portion subset of that network. For example, a LAN can be on a WAN, but only the LAN under the control of an entity; so if an engine controls policy on the network, it may be that the engine only controls policy on the LAN (or some other subset of the WAN). Private networks include a head office and optional regional offices (collectively, offices). Many offices enable remote users to connect to the private network offices via some other network, such as the Internet.

The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to those of skill in the relevant art.

For illustrative purposes, it is assumed the computer-readable medium 102 broadly includes, as understood from relevant context, anything from a minimalist coupling of the components, or a subset of the components, illustrated in the example of FIG. 1, to every component of the Internet and networks coupled to the Internet. In the example of FIG. 1, the computer-readable medium 102 can include a data path, such as a bus, in a computer. In such an implementation, one or more of the components illustrated in the example of FIG. 1 can be implemented on the same machine.

Referring once again to the example of FIG. 1, in the example of FIG. 1, the complex equipment maintenance server 104 is coupled to the computer-readable medium 102. The complex equipment maintenance server 104 can be implemented on a known or convenient computer system. The complex equipment maintenance server 104 is intended to illustrate one server that has the novel functionality, but there could be practically any number of servers coupled to the computer-readable medium 102 that meet this criterion. Moreover, partial functionality might be provided by a first server and partial functionality might be provided by a second server, where together the first and second server provide the full functionality.

Functionality of the complex equipment maintenance server 104 can be carried out by one or more engines. As used in this paper, an engine includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor.

In the example of FIG. 1, the clients 106 are coupled to the computer-readable medium 102. The clients 106 can be implemented on one or more known or convenient computer systems. As used in this example, the clients 106 are clients of the complex equipment maintenance server 104. (The various components of the example of FIG. 1 can have other client-server relationships, as well.) In a specific implementation, the clients can both receive information about complex information from the complex equipment maintenance server 104 and provide inputs to the complex equipment maintenance server 104.

The complex equipment 108 is intended to represent the complex equipment that is being maintained by the system. In the example of FIG. 1, the complex equipment is coupled to the computer-readable medium 102 by the complex equipment sensor reporting engine 110. In an alternative, the complex equipment 108 can receive maintenance-related inputs, as well. (Of course, the complex equipment 108 can receive other types of inputs, too.)

In the example of FIG. 1, the complex equipment sensor reporting engine 110 receives sensor results from sensors operationally connected to the complex equipment 108. The complex equipment sensor reporting engine 110 can preprocess the sensor results or send the raw data to the complex equipment maintenance server 104 for interpretation, reporting, or the like. Devices that act as sensors local to the complex equipment 108, but that are not dedicated sensors operationally connected to the complex equipment 108, such as a smart phone camera, diagnostic tool, or the like, can be treated as sensors coupled to the complex equipment sensor reporting engine 110. Conceptually, the complex equipment sensor reporting engine 110 is treated as the engine responsible for reporting on conditions of or environment surrounding the complex equipment 108, while the complex equipment parameter provisioning engine 114 (described below) is responsible for reporting installation-agnostic data about complex equipment.

In the example of FIG. 1, the complex equipment parameters datastore 112 is coupled to the computer-readable medium 102 by the complex equipment parameter provisioning engine 114. The complex equipment parameters datastore 112 can store information useful to an understanding of complex equipment operation, maintenance scheduling recommendations, or the like. The complex equipment parameters datastore 112, and other datastores described in this paper, can be implemented, for example, as software embodied in a physical computer-readable medium on a general- or specific-purpose machine, in firmware, in hardware, in a combination thereof, or in any applicable known or convenient device or system. This and other repositories described in this paper are intended, if applicable, to include any organization of data, including tables, comma-separated values (CSV) files, traditional databases (e.g., SQL), or other known or convenient organizational formats.

In an example of a system where the complex equipment parameters datastore 112 is implemented as a database, a database management system (DBMS) can be used to manage the complex equipment parameters datastore 112. In such a case, the DBMS may be thought of as part of the complex equipment parameters datastore 112 or as part of the complex equipment parameter provisioning engine, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. An optimal structure may vary depending upon application requirements (e.g., speed, reliability, maintainability, scalability, and cost). One of the more common models in use today is the ad hoc model embedded in SQL. Data structures can include fields, records, files, objects, and any other applicable known or convenient structures for storing data. A database query language can enable users to query databases, and can include report writers and security mechanisms to prevent unauthorized access. A database transaction mechanism ideally ensures data integrity, even during concurrent user accesses, with fault tolerance. DBMSs can also include a metadata repository; metadata is data that describes other data.

In the example of FIG. 1, the complex equipment parameter provisioning engine 114 acts as a data server for the complex equipment parameters datastore 112. Typically, the term “server” is reserved for situations where the engine has a client-server relationship with some other component. In an implementation where, e.g., the complex equipment parameters 112 and the complex equipment maintenance server 104 are local to one another, the complex equipment parameter provisioning engine 114 could be considered “part of” the complex equipment maintenance server 104, or in a database implementation, a database interface.

In the example of FIG. 1, the complex equipment parameter provisioning engine 114 can include data from any applicable sources, including maintenance requirements datastores (such as documents), data feeds, schedules, work orders, work lists, manual input, or the like. The platform can include an application programming interface (API) to facilitate integration of the system with various sources of data (and for outputs, as well). Thus, the complex equipment parameters datastore 112 can represent any applicable source of complex equipment data available from a source other than the complex equipment 108 itself (or sensors operationally connected thereto). Advantageously, the complex equipment parameter provisioning engine 114 can provide information about complex equipment even if the complex equipment was implemented prior to an implementation of the system illustrated in the example of FIG. 1. Thus, the platform can integrate with existing equipment systems. Moreover, the platform can be upgraded or improved without interfering with installed equipment.

Advantageously, the platform is designed to satisfy underserved customer needs in the job of maintaining complex equipment. From the customer's perspective, better satisfying customer needs is how the platform helps them get the job done better. For example, the platform can synchronize with a calendar to schedule maintenance, identify maintenance issues from sensors on the complex equipment, calculate time required for maintenance, create a maintenance plan, and monitor maintenance activities. If maintenance requirements change, for example, the platform can modify the maintenance schedule and notify regarding the new requirements. The features of the platform help customers achieve one or more of the 102 identified outcomes for 14 job steps of a job map for maintaining complex equipment.

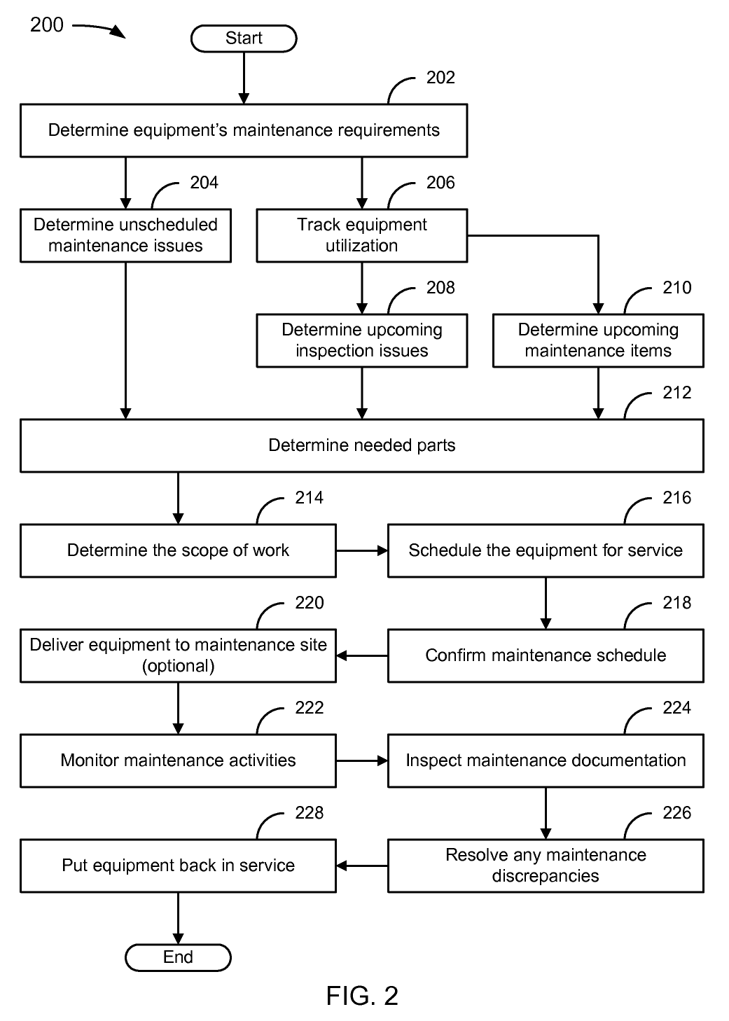

FIG. 2 depicts a flowchart 200 of an example of a job map for maintaining complex equipment. In the example of FIG. 2, the flowchart 200 starts at module 202 where equipment's maintenance requirements are determined. Maintenance requirements can be standard for equipment, as set by a manufacturer, installer, or the like. The requirements need not be from an “official” source if other data is deemed to be more useful. The maintenance requirements can be considered a baseline maintenance schedule that does not take into account use or environmental factors (though such factors could be generally input in advance).

In the example of FIG. 2, the flowchart 200 continues to module 204 where unscheduled maintenance issues are determined. Any maintenance issues that can be identified based upon the maintenance requirements that have not been scheduled can be scheduled.

In the example of FIG. 2, the flowchart 200 takes a parallel path to module 206 where equipment utilization is tracked. Equipment utilization can be tracked using sensors at or near a complex equipment installation site, mobile sensors carried by people (and perhaps animals or machines), manual inputs from workers, or the like.

In the example of FIG. 2, the flowchart 200 continues to module 208 where upcoming inspection issues are determined. Based upon equipment utilization, environmental factors, and maintenance requirements or suggestions, it may be desirable to schedule inspections.

In the example of FIG. 2, the flowchart 200 takes a parallel path to module 210 where upcoming maintenance items are determined. Based upon equipment utilization, environmental factors, and maintenance requirements or suggestions, upcoming maintenance items can be determined.

In the example of FIG. 2, the three parallel paths (from modules 204, 208, and 210) converge as flowchart 200 continues to module 212 where needed parts are determined. A complex equipment maintenance platform can make a determination regarding maintenance and determine needed parts based upon that determination.

In the example of FIG. 2, the flowchart 200 continues to module 214 where scope of work is determined. Scope of work can include amount of time complex equipment will be taken out of service, amount of human resources that must be allocated to the maintenance, cost and time for third party contributions, and the like.

In the example of FIG. 2, the flowchart 200 continues to module 216 where equipment is scheduled for service. It may be noted that scheduling the equipment for service may or may not entail re-determining needed parts or re-determining scope of work (modules 212 and 214, respectively). Scheduling the equipment for service can include synchronizing users' calendars with a maintenance schedule. The scheduling can take into account open time slots on user calendars, locations of users with relevant expertise, third party availability, and the like. In a specific implementation, the scheduling is fully automated.

In the example of FIG. 2, the flowchart 200 continues to module 218 where maintenance schedule is confirmed. Confirmation can include an administrative sign-off on the scheduled activity, confirmation from relevant parties that the schedule is acceptable, etc.

In the example of FIG. 2, the flowchart 200 continues to optional module 220 where equipment is delivered to maintenance site. Part of scheduling can include scheduling delivery, if applicable.

In the example of FIG. 2, the flowchart 200 continues to module 222 where maintenance activities are monitored. It is generally desirable to monitor maintenance so as to adjust maintenance needs as new action items are uncovered, if any.

In the example of FIG. 2, the flowchart 200 continues to module 224 where maintenance documentation is inspected. Regulations may require certain historical logs. It can also be desirable to maintain historical logs for later reference.

In the example of FIG. 2, the flowchart 200 continues to module 226 where maintenance discrepancies are resolved, if any. Whether maintenance discrepancies exist will depend upon what is identified during monitoring of the maintenance.

In the example of FIG. 2, the flowchart 200 ends at module 228 where equipment is put back in service. It may or may not be necessary to take equipment out of service for maintenance, but it is to be expected for certain equipment and/or for certain maintenance actions. In such cases, the equipment must be put back into service.

Business process management (BPM), as used in this paper, is a technique intended to align organizations with the needs of clients by continuously improving processes. BPM is an advantageous implementation because it tends to promote business efficacy while striving for innovation and integration with technology. It should be noted that business process modeling and business process management are not the same, and, confusingly, share the same acronym. In this paper, business process management is given the acronym BPM, but business process modeling is not given an acronym. Business process modeling is often, though not necessarily, used in BPM. Business process modeling is a way of representing processes in systems or software. The models are typically used as tools to improve process efficiency and quality, and can use Business Process Modeling Notation (BPMN) or some other notation to model business processes.

A business process, as used in this paper, is a collection of related, structured activities or tasks that produce a service or product for a particular client. Business processes can be categorized as management processes, operational processes, and supporting processes. Management processes govern the operation of a system, and include by way of example but not limitation corporate governance, strategic management, etc. Operational processes comprise the core business processes for a company, and include by way of example but not limitation, purchasing, manufacturing, marketing, and sales. Supporting processes support the core processes and include, by way of example but not limitation, accounting, recruiting, technical support, etc.

A business process can include multiple sub-processes, which have their own attributes, but also contribute to achieving the goal of the super-process. The analysis of business processes typically includes the mapping of processes and sub-processes down to activity level. A business process is sometimes intended to mean integrating application software tasks, but this is narrower than the broader meaning that is frequently ascribed to the term in the relevant art, and as intended in this paper. Although the initial focus of BPM may have been on the automation of mechanistic business processes, it has since been extended to integrate human-driven processes in which human interaction takes place in series or parallel with the mechanistic processes.

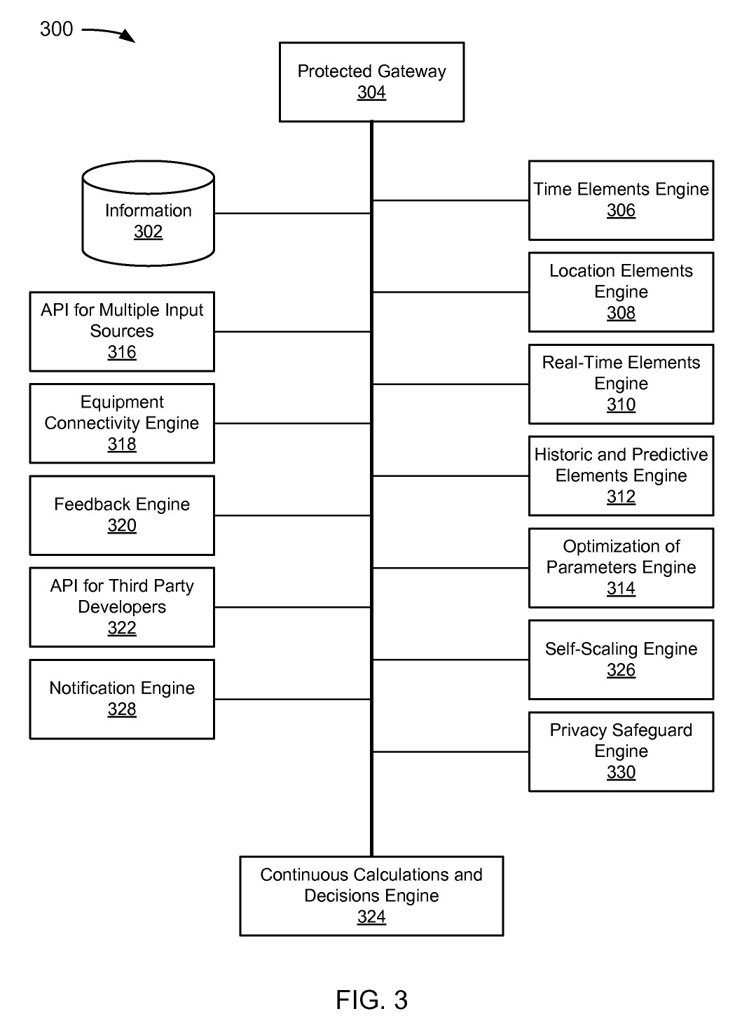

FIG. 3 depicts a diagram 300 of an example of a complex equipment maintenance platform. The platform is intended to help a user maintain complex equipment with minimal or no input or decision-making by the user. In a specific implementation, the platform obtains relatively large amounts of data and information that impacts maintaining complex equipment and informs the user of recommended actions. Solution features can be integrated into the platform and delivered to the user through one or more devices and/or applications. In the example of FIG. 3, the diagram 300 includes an information datastore 302, a protected gateway 304, a time elements engine 306, a location elements engine 308, a real-time elements engine 310, a historic and predictive elements engine 312, an optimization of parameters engine 314, an API for multiple input sources 316, an equipment connectivity engine 318, a feedback engine 320, an API for third party developers 322, a continuous calculations and decisions engine 324, a self-scaling engine 326, a notification engine 328, and a privacy safeguard engine 330.

In the example of FIG. 3, the information datastore 302 incorporates information from multiple datastores such a maintenance requirements datastore, an equipment utilization information datastore, an equipment sensor datastore, etc. The information datastore 302 thus includes any information useful in determining maintenance needs, whether inherent in the design of the equipment, or based upon use after deployment. Design-specific datastores can even be updated based on data derived from deployment to tweak maintenance recommendations across an enterprise or for all users of the equipment.

In the example of FIG. 3, the protected gateway 304 ensures the platform does not become a “hacker's pathway” to equipment control systems. Known or convenient security techniques can be employed to ensure system security.

In the example of FIG. 3, the time elements engine 306 ensures the platform knows what time it is and can schedule maintenance.

In the example of FIG. 3, the location elements engine 308 can identify where complex equipment is located. It may also be desirable to locate users, at least relative to the complex equipment location.

In the example of FIG. 3, the real time elements engine 310 delivers real-time information to users, such as a notification or display that equipment is currently operating. In a specific implementation, the platform can incorporate up-to-date data as rapidly as the data becomes available.

In the example of FIG. 3, the historic and predictive elements engine 312 can combine historic logs with a prediction engine. In a specific implementation, the platform can modify generic maintenance parameters for equipment based upon historic data for deployed equipment.

In the example of FIG. 3, the optimization of parameters engine 314 can optimize parameters to find a solution. In a specific implementation, the platform has a robust algorithm implemented in order to allow the platform to make a decision. A goal is to minimize the need for a customer to think about how to best maintain a complex piece of equipment. The result is a platform that does not need any user input regarding maintenance (though some input may or may not be desirable in certain instances).

In the example of FIG. 3, the API for multiple input sources 316 enables the platform to communicate with a variety of different sources of or destinations for data. This can be useful for receiving data from sensors, data feeds, and manual inputs, and for providing instructions to sensors or output to display devices. The API for multiple input sources 316 can include a number of different APIs that are referred to collectively as the API for multiple input sources.

In the example of FIG. 3, the equipment connectivity engine 318 includes a communication link between equipment and the platform. In a specific implementation, the equipment connectivity engine 318 can use equipment systems and sensors to connect to the platform.

In the example of FIG. 3, the feedback engine 320 includes a feedback channel for improving decision-making capabilities. In a specific implementation, the platform learns over time and becomes more accurate in order to understand maintenance requirements of complex equipment.

In the example of FIG. 3, the API for third party developers 322 makes it easier for third party developers to create applications on the platform. The API for third party developers 322 can include a number of different APIs that are referred to collectively as the API for third party developers.

In the example of FIG. 3, the continuous calculations and decisions engine 324 enables the platform to continuously deliver information. Continuous calculations and decisions can be accomplished by using a server that is not taken off-line to the extent that is possible. Moreover, a breakdown in communications links does not necessarily mean the platform ceases to perform calculations and make decisions. In a specific implementation, the continuous calculations and decisions engine 324 can operate without wireless connectivity. For example, the platform can cache data in case of a lapse in cellular or other wireless coverage and, if connectivity is lost, the system does not “go blank” and will have the latest information as of when connectivity was lost (and perhaps updated through other channels while connectivity is down).

In the example of FIG. 3, the self-scaling engine 326 ensures no additional end-user hardware is required. In a specific implementation, the platform can detect resources available and scale service to the available resource. Thus, minimally essential capability should be available on user owned device, regardless of the capabilities of the device beyond a certain constant threshold. As more resources become available, service scales upward. In a specific implementation, the platform can work on a variety of popular devices, such as web-enabled devices, PCs, tablets, smartphones, etc.

In the example of FIG. 3, the notification engine 328 can provide notifications to users. Devices with the capability can receive SMS notifications or other types of messages depending upon the capabilities of the device and implementation- and/or configuration-specific capabilities of the platform. The platform provides end user alerts, for example, an updated maintenance requirement based on utilization of the equipment.

In the example of FIG. 3, the privacy safeguard engine 330 provides privacy safeguards that are determined to be appropriate generally or for a given implementation. The platform can minimize privacy barriers to adoption and use of the system. In a specific implementation, individually identifiable information is not retained at any central server sites longer than necessary. Alternatively or in addition, individual historical data is retained only on user-controlled devices.

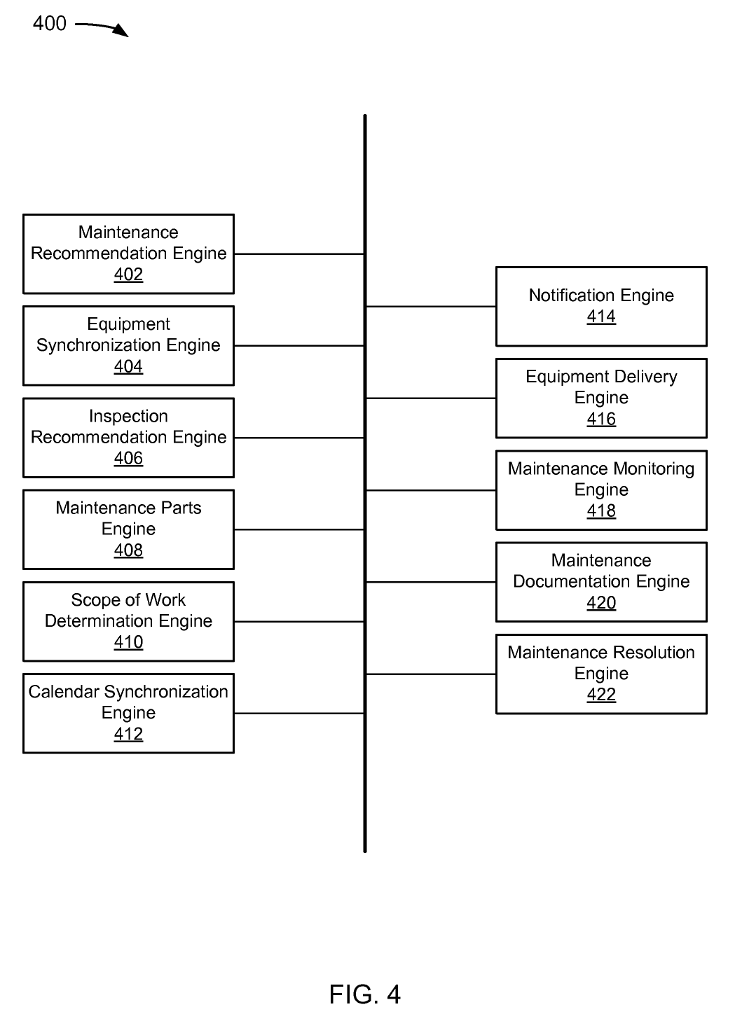

FIG. 4 depicts a diagram 400 of an example of a system for maintaining complex equipment. In the example of FIG. 4, the diagram 400 includes a maintenance recommendation engine 402, an equipment synchronization engine 404, an inspection recommendation engine 406, a maintenance parts engine 408, a scope of work determination engine 410, a calendar synchronization engine 412, a notification engine 414, an equipment delivery engine 416, a maintenance monitoring engine 418, maintenance documentation engine 420, and a maintenance resolution engine 422.

In the example of FIG. 4, the maintenance recommendation engine 402 has access to standard maintenance information associated with a relevant complex equipment system, historical maintenance data associated with the relevant complex equipment system, and perhaps other data that is considered useful in determining whether unscheduled maintenance issues exist.

In the example of FIG. 4, the equipment synchronization engine 404 is coupled to the maintenance recommendation engine 402. The equipment synchronization engine 404 enables a job executor to automatically monitor maintenance recommendations based upon utilization of the equipment. Monitored parameters can include operating parameters (e.g., temperature, fluid levels, frequency of use, etc.) and environmental parameters (e.g., humidity, temperature, particulates, etc.). The equipment synchronization engine 404 can provide the maintenance recommendation engine 402 with data to facilitate the maintenance recommendation engine 402 in determining upcoming maintenance items for the relevant complex equipment system.

In the example of FIG. 4, the inspection recommendation engine 406 is coupled to the equipment synchronization engine 404. The inspection recommendation engine 406 receives data from the equipment synchronization engine 404 (or from sensors associated with the relevant complex equipment system). In an alternative, the inspection recommendation engine 406 and the maintenance recommendation engine 402 can be considered a single maintenance recommendation engine that determines unscheduled maintenance issues, determines upcoming inspection issues, and determines upcoming maintenance issues.

In the example of FIG. 4, the maintenance parts engine 408 is coupled to the maintenance recommendation engine 402 and the inspection recommendation engine 406. The maintenance parts engine 408 determines needed parts based upon recommended maintenance and inspections. In a specific implementation, the maintenance parts engine 408 can also place orders for parts or send a notification to a user to complete the order, request a bid for parts, and/or manage parts inventory for the relevant complex equipment system (and potentially other applicable equipment systems if parts are shared, space must be managed, or the like).

In the example of FIG. 4, the scope of work determination engine 410 is coupled to the maintenance parts engine 408. The scope of work determination engine 410 can make decisions about what maintenance and/or inspections can be carried out. The scope of work can be determined from standard maintenance information and historical maintenance data. The scope of work determination engine 410 can be considered part of a maintenance decision engine that can also include the maintenance recommendation engine 402 and/or the inspection recommendation engine 406.

In the example of FIG. 4, the calendar synchronization engine 412 is coupled to the scope of work determination engine 410. The calendar synchronization engine 412 can synchronize a user calendar with the platform. In a specific implementation, when a user's calendar is synchronized with the platform, the system can automatically calculate a maintenance schedule, determined maintenance recommendations, and schedule the maintenance on the user's calendar. The calendar synchronization engine 412 enables the platform to track the user's and the relevant complex equipment system's maintenance schedules and allocate time for maintenance.

In the example of FIG. 4, the notification engine 414 is coupled to the calendar synchronization engine 412. The notification engine 414 can provide a user with recommended maintenance for approval by the user. Notifications can also be sent to update a user regarding changes to a previously scheduled action. The user can modify details of the maintenance schedule, respond to open items regarding parts that need be ordered or other issues, and ultimately confirm the maintenance schedule and related action items. Actions taken by the user may or may not result in the need for additional determinations related to needed parts, changes to the scope of the work, changes to scheduling, etc.

In the example of FIG. 4, the equipment delivery engine 416 is coupled to the notification engine 414. In some instances, which can vary depending upon the equipment, the type of maintenance required, etc., it may become desirable to deliver the relevant complex equipment system, or a portion thereof, to a maintenance site. The equipment delivery engine 416 can handle the equipment delivery details, including scheduling third parties to pick up and return, a job executor to be present for delivery or other purposes, handling payments to third parties, etc. Not all implementations will need an equipment delivery engine 416, and not all maintenance scheduling will necessarily entail equipment delivery.

In the example of FIG. 4, the maintenance monitoring engine 418 is coupled to the equipment delivery engine 416. The maintenance monitoring engine 418 periodically, occasionally, or continuously monitors activities taken in association with maintenance. Information about the maintenance can be input from more than one source, including sensors installed at the site of the relevant complex equipment system, manual inputs by technicians or workers, inputs from mobile sensors (e.g., carried by the technicians), or the like. Using the inputs, the platform can revisit determinations regarding upcoming maintenance items, determining needed parts, determining scope of work, scheduling the equipment for service, confirming maintenance schedules, etc.

In the example of FIG. 4, the maintenance documentation engine 420 is coupled to the maintenance monitoring engine 418. The maintenance documentation engine 420 enables a user to document maintenance and verify compliance with regulations or other requirements. In a specific implementation, the maintenance documentation engine 420 enables the user to review historical documentation and compliance.

In the example of FIG. 4, the maintenance resolution engine 422 is coupled to the maintenance documentation engine 420. The maintenance resolution engine 422 enables the user to resolve maintenance discrepancies. The maintenance resolution engine 422 can also make decisions on behalf of a user about discrepancy resolution based upon one or more input sources. The maintenance resolution engine 422 can also put the relevant complex equipment system back in service or schedule the system to be put back in service, if the complex equipment had to be taken out of service for maintenance or inspection.

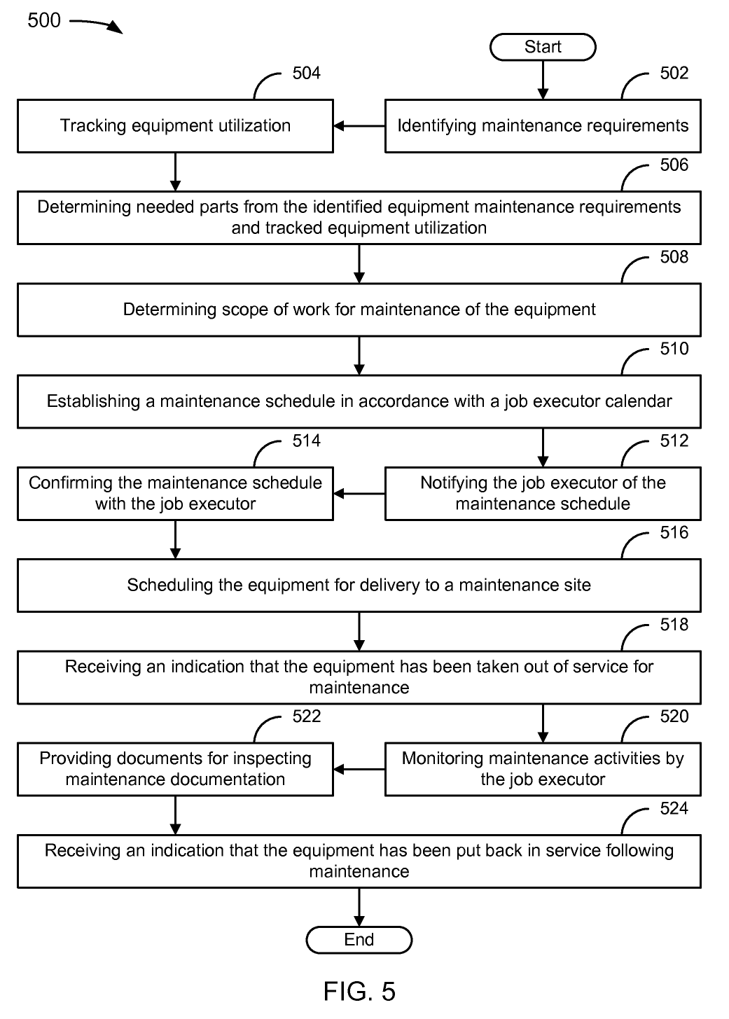

FIG. 5 depicts a flowchart 500 of an example of a method for maintaining complex equipment at a complex equipment maintenance platform. In the example of FIG. 5, the flowchart 500 starts at module 502 with identifying maintenance requirements and continues to module 504 with tracking equipment utilization; module 506 with determining needed parts from the identified equipment maintenance requirements and tracked equipment utilization; module 508 with determining scope of work for maintenance of the equipment; module 510 with establishing a maintenance schedule in accordance with a job executor calendar; module 512 with notifying the job executor of the maintenance schedule; module 514 with confirming the maintenance schedule with the job executor; module 516 with scheduling the equipment for delivery to a maintenance site; module 518 with receiving an indication that the equipment has been taken out of service for maintenance; module 520 with monitoring maintenance activities by the job executor; and module 522 with providing documents for inspecting maintenance documentation, and ends at module 524 with receiving an indication that the equipment has been put back in service following the maintenance.

The detailed description discloses examples and techniques, but it will be appreciated by those skilled in the relevant art that modifications, permutations, and equivalents thereof are within the scope of the teachings. It is therefore intended that the following appended claims include all such modifications, permutations, and equivalents. While certain aspects of the invention are presented below in certain claim forms, the applicant contemplates the various aspects of the invention in any number of claim forms. For example, while only one aspect of the invention is recited as a means-plus-function claim under 35 U.S.C. sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6.) Accordingly, the applicant reserves the right to add additional claims after filing the application to pursue such additional claim forms for other aspects of the invention.

What is claimed is:

1. A system comprising:
a complex equipment maintenance server configured for operation with one or more clients;
complex equipment installed at an installation location;
a complex equipment sensor reporting engine configured to report data from the installation location to the complex equipment maintenance server;
a complex equipment parameters datastore;
a complex equipment parameter provisioning engine, coupled to the complex equipment parameters datastore, for providing complex equipment parameters to the complex equipment maintenance server;
wherein, in operation, the complex equipment maintenance server:
identifies equipment maintenance requirements for the complex equipment based at least on data from the complex equipment parameter provisioning engine;
tracks equipment utilization based at least on data from the installation location provided by the complex equipment sensor reporting engine;
determines needed parts from the equipment maintenance requirements and tracked equipment utilization;
determines scope of work for the maintenance of the complex equipment;
schedules the complex equipment for maintenance in accordance with a job executor calendar;
notifies the job executor of the maintenance schedule, wherein the job executor can be notified through a client of the one or more clients with which the complex equipment maintenance server is configured for operation;
monitors maintenance activities by the job executor;
receives an indication that maintenance is complete for the complex equipment.

2. The system of claim 1, wherein scheduling the equipment for maintenance includes creating a maintenance schedule, wherein, in operation, the complex equipment maintenance server confirms the maintenance schedule.

3. The system of claim 1, wherein, in operation, the complex equipment maintenance server schedules the equipment for delivery to a maintenance site.

4. The system of claim 1, wherein, in operation, the complex equipment maintenance server provides maintenance documentation for inspection.

5. The system of claim 1, wherein, in operation, the complex equipment maintenance server identifies maintenance discrepancies.

6. The system of claim 1, wherein, in operation, the complex equipment maintenance server receives a first notification that the complex equipment is taken out of service for maintenance and receives a second notification that the complex equipment has been put back in service following the maintenance.

7. The system of claim 1, further comprising an information datastore incorporating a maintenance requirements datastore, an equipment utilization information datastore, and an equipment sensor datastore, wherein the maintenance requirements datastore includes the complex equipment parameters datastore.

8. The system of claim 1, further comprising a protected gateway to secure equipment control systems.

9. The system of claim 1, further comprising a time elements engine configured to synchronize the maintenance schedule with the job executor calendar.

10. The system of claim 1, further comprising a location elements engine configured to reconcile the installation location with a job executor location.

11. The system of claim 1, further comprising a real-time elements engine configured to enable real-time information delivery from the complex equipment sensor reporting engine.

12. The system of claim 1, further comprising a historic and predictive elements engine configured to assist the complex equipment maintenance server in determining needed parts or determining the scope of work.

13. The system of claim 1, further comprising an optimization of parameters engine configured to make decisions regarding maintenance on behalf of the job executor.

14. The system of claim 1, further comprising an application programming interface (API) for multiple input sources and third party developers.

15. The system of claim 1, further comprising an equipment connectivity engine configured to facilitate a connection between complex equipment electronic systems and sensors at the installation location.

16. The system of claim 1, further comprising feedback engine configured to learn from historical data how to make better maintenance-related decisions.

17. The system of claim 1, further comprising continuous calculations and decisions engine configured to enable the complex equipment maintenance server to continuously make calculations and decisions.

18. The system of claim 1, further comprising a self-scaling engine configured to detect available resources and scale service to the available resources.

19. A method comprising, at an automated complex equipment maintenance platform:
identifying equipment maintenance requirements;
tracking equipment utilization;
determining needed parts from the identified equipment maintenance requirements and tracked equipment utilization;
determining scope of work for maintenance of the equipment;
establishing a maintenance schedule in accordance with a job executor calendar;
notifying the job executor of the maintenance schedule;
confirming the maintenance schedule with the job executor;
scheduling the equipment for delivery to a maintenance site;
receiving an indication that the equipment has been taken out of service for maintenance;
monitoring maintenance activities by the job executor;
providing documents for inspecting maintenance documentation;
receiving an indication that the equipment has been put back in service following the maintenance.

20. A system comprising:
a means for identifying equipment maintenance requirements;
a means for tracking equipment utilization;
a means for determining needed parts from the identified equipment maintenance requirements and tracked equipment utilization;
a means for determining scope of work for maintenance of the equipment;
a means for establishing a maintenance schedule in accordance with a job executor calendar;
a means for notifying the job executor of the maintenance schedule;
a means for confirming the maintenance schedule with the job executor;
a means for scheduling the equipment for delivery to a maintenance site;
a means for receiving an indication that the equipment has been taken out of service for maintenance;
a means for monitoring maintenance activities by the job executor;
a means for providing documents for inspecting maintenance documentation;
a means for receiving an indication that the equipment has been put back in service following the maintenance.
